(19) United States
(12) Patent Application Publication
(10) Pub. No.: US 2025/0096630 A1
(43) Pub. Date: Mar. 20, 2025

(54) MOTOR

(71) Applicant: NIDEC CORPORATION, Kyoto (JP)

(72) Inventor: Kosuke TAKEDA, Kyoto (JP)

(21) Appl. No.: 18/718,801

(22) PCT Filed: Nov. 1, 2022
(86) PCT No.: PCT/JP2022/040933

§ 371 Date: Nov. 29, 2024

(30) Foreign Application Priority Data
Dec. 17, 2021 (JP) 2021-205257

(51) Int. Cl. H02K 1/32; H02K 1/16; H02K 1/276

(52) U.S. Cl. CPC H02K 1/32; H02K 1/16; H02K 1/276

(57) ABSTRACT

A motor includes a rotor and a stator. The rotor includes a shaft extending in the axial direction of the central axis, and a rotor core having a shaft insertion hole into which the shaft is inserted. The motor has a fan that is fixed to the shaft or the rotor core at a position axially outside the rotor core and rotates together with the rotor core. The rotor core has an air passage. The shaft has a shaft inner passage. The air passage includes a first rotor core opening opened to an axial end surface of the rotor core and a second rotor core opening opened to an inner surface of the shaft insertion hole. The shaft inner passage includes a first shaft opening opened at a position on the axially outer side with respect to the fan, and a second shaft opening opened at a position connected to the second rotor core opening.

### CROSS-REFERENCE TO RELATED APPLICATIONS

The present application is a National Phase of International Application No. PCT/JP2022/040933 filed Nov. 1, 2022, which claims priority to Japanese Application No. 2021-205257, filed Dec. 17, 2021.

### TECHNICAL FIELD

The present invention relates to a motor.

### BACKGROUND ART

A motor having a configuration for cooling a stator is known. For example, an electric motor disclosed in Patent Literature 1 includes a rotor including a rotor core that rotates about a rotation axis, permanent magnets inserted into magnet insertion holes formed in the rotor core, and first and second end plates respectively provided on both end surfaces in an axial direction of the rotor core. The first end plate includes a base portion that closes one end side of the magnet insertion hole, and a blade portion provided on a surface of the base portion. The rotor has a cooling hole that is opened between the blade portion of the first end plate and the rotating shaft, and penetrates the rotor core and the second end plate. When the rotor is rotating, the blade portion generates a pressure difference between both ends in the axial direction of the rotor.

### CITATIONS LIST

### Patent Literature

Patent Literature 1: JP 6818869 B

### SUMMARY OF INVENTION

### Technical Problems

In the electric motor disclosed in Patent Literature 1, when the rotor is rotating, the blade portion generates a pressure difference between both ends in the axial direction of the rotor. Due to the pressure difference, the air flows in one direction in the axial direction in the cooling hole in the rotor core. As a result, the rotor core is cooled. However, the electric motor of Patent Literature 1 has a configuration in which the air flows only inside the rotor core and only in one axial direction. There is a demand to realize a motor capable of cooling a rotor core more efficiently than a configuration in which the air flows only inside the rotor core and only in one axial direction.

An object of the present invention is to provide a motor capable of more efficiently cooling a rotor core by using a fan that rotates together with the rotor core.

### Solutions to Problems

A motor according to an exemplary embodiment of the present invention includes a rotor and a stator. The rotor includes a shaft extending in an axial direction of the central axis, and a rotor core having a shaft insertion hole into which the shaft is inserted. The stator is located radially outside the rotor. Further, the motor includes a fan that is fixed to the shaft or the rotor core at a position axially outside the rotor core and rotates together with the rotor core. The rotor core includes an air passage. The shaft has a shaft inner passage. The air passage includes a first rotor core opening opened to an axial end surface of the rotor core, and a second rotor core opening opened to the shaft insertion hole. The shaft inner passage includes a first shaft opening opened at a position on the axially outer side with respect to the fan, and a second shaft opening opened at a position connected to the second rotor core opening.

### Advantageous Effects of Invention

According to the motor according to an exemplary embodiment of the present invention, since the first shaft opening is located on the axially outer side with respect to the fan, when the fan rotates with the rotation of the rotor core, the air flows through the shaft inner passage. Since the second rotor core opening and the second shaft opening are connected to each other, the air flows through the shaft inner passage and the air passage of the rotor core connected to the shaft inner passage. As a result, the air can flow into the shaft and the rotor core by the rotation of the fan, and the rotor core can be efficiently cooled.

### BRIEF DESCRIPTION OF DRAWINGS

FIG. 1 is a diagram illustrating a schematic configuration of a motor according to a first embodiment, in a cross section including a central axis.

FIG. 2 is a perspective view illustrating an example of a shaft according to the first embodiment.

FIG. 3 illustrates an example of a rotor core according to the first embodiment.

FIG. 4 is a perspective view illustrating an example of a rotor core, a first fan, and a second fan to be described later according to the first embodiment.

FIG. 5 is a diagram illustrating an example of the first fan according to the first embodiment.

FIG. 6 is a diagram illustrating an example of the second fan according to the first embodiment.

FIG. 7 illustrates an example of a core plate according to the first embodiment.

FIG. 8 is a diagram illustrating a cross section of a rotor core including the central axis and a connection passage portion.

FIG. 9 is a diagram illustrating an example of a motor according to a modification of the first embodiment.

### DESCRIPTION OF EMBODIMENT

Hereinafter, an exemplary embodiment of the present invention will be described in detail with reference to the drawings. The same or corresponding parts in the drawings are denoted by the same reference numerals, and the description thereof will not be repeated. In addition, the dimensions of the components in the drawings do not faithfully represent the actual dimensions of the components, the dimensional ratios of the components, and the like.

Note that in the following description of a motor 100, a direction parallel to a central axis P of the motor 100 is referred to as an “axial direction”, a direction perpendicular to the central axis P is referred to as a “radial direction”, and a direction along an arc centered on the central axis P is referred to as a “circumferential direction”. In the following description and the drawings, “P1” is used as a reference sign indicating one side in the axial direction, and “P2” is used as a reference sign indicating the other side in the axial direction. However, this definition is not intended to limit the orientation of the motor 100 when in use.

Further, in the following description, expressions such as “fixed”, “connected”, and “attached” (hereinafter, fixed or the like) are used not only when the members are directly fixed or the like to each other, but also when the members are fixed or the like via another member. That is, in the following description, the expression “fixed or the like” includes meanings such as direct and indirect fixation between members.

### First Embodiment

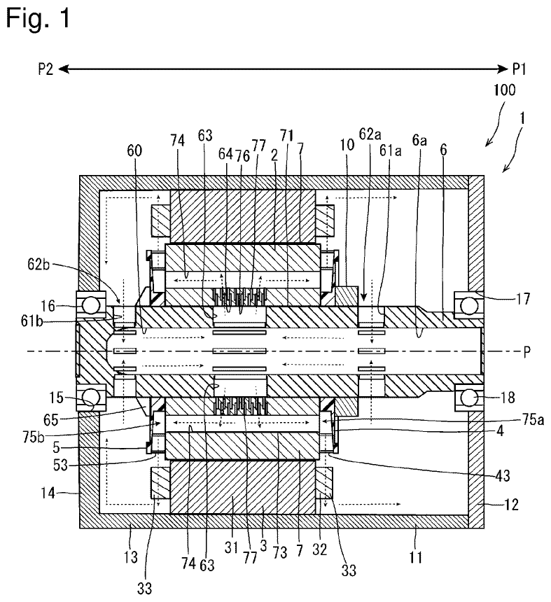

An example of the motor 100 according to the first embodiment will be described with reference to FIGS. 1 to 8.

### (Configuration of Motor 100)

The motor 100 according to the first embodiment can be used as a drive source that rotates an axle of a vehicle. Examples of a vehicle include a hybrid vehicle (HEV), a plug-in hybrid vehicle (PHV), and an electric vehicle (EV). The motor 100 according to the first embodiment can also be used as a drive source for operating devices, equipment, and members other than the vehicle.

FIG. 1 is a diagram illustrating a schematic configuration of the motor 100 according to the first embodiment, in a cross section including the central axis P. As illustrated in FIG. 1, the motor 100 includes a casing 1, a fixing member 10, a rotor 2, a stator 3, a first fan 4, and a second fan 5. In the first embodiment, the motor 100 is a so-called inner rotor type motor 100 in which the rotor 2 is located so as to be rotatable about the central axis P in the cylindrical stator 3.

### (Casing)

The casing 1 includes a first casing member 11 and a second casing member 12.

The first casing member 11 includes a cylindrical portion 13 and a bottom plate 14. The cylindrical portion 13 has a cylindrical shape and is located radially outside the stator 3. The cylindrical portion 13 extends in the axial direction and has an opening on one axial side P1. The bottom plate 14 extends radially inward from the end on the other axial side P2 of the cylindrical portion 13. The bottom plate 14 has a bottom plate through-hole 15 and a first bearing 16. The bottom plate through-hole 15 penetrates the bottom plate 14 in the axial direction. The first bearing 16 has a tubular shape and is located radially inside the bottom plate through-hole 15.

The second casing member 12 is an annular plate member. The second casing member 12 closes the opening on the one axial side P1 of the cylindrical portion 13. The second casing member 12 has a casing through hole 17 axially penetrating the second casing member 12, and a second bearing 18. The second bearing 18 has a tubular shape and is located radially inside the casing through hole 17.

### (Rotor)

As illustrated in FIG. 1, the rotor 2 includes a shaft 6 and a rotor core 7.

### (Shaft)

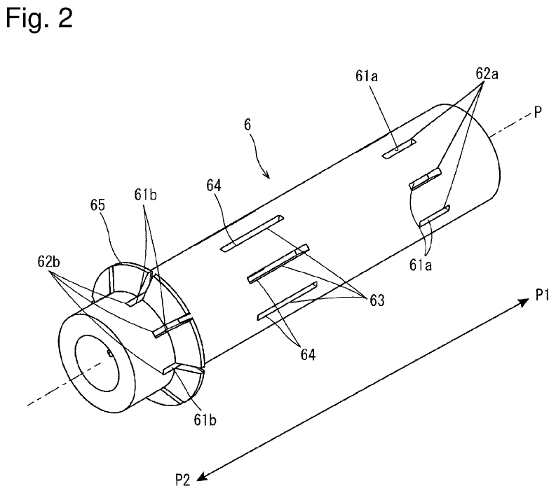

FIG. 2 is a perspective view illustrating an example of the shaft 6 according to the first embodiment. As illustrated in FIGS. 1 and 2, the shaft 6 has a hollow rod shape and extends in the axial direction. The end on the one axial side P1 of the shaft 6 is inserted into the second bearing 18. The end on the other axial side P2 of the shaft 6 is inserted into the first bearing 16. The first bearing 16 and the second bearing 18 rotatably support the shaft 6. For example, the first bearing 16 and the second bearing 18 are bearings. As a result, the shaft 6 is rotatable about the central axis P.

As illustrated in FIG. 1, the shaft 6 has a shaft inner passage 6a therein. The shaft inner passage 6a is a passage for allowing the air to flow in the shaft 6. The shaft inner passage 6a includes a shaft inner axial passage portion 60, first passage portions 61a and 61b, first shaft openings 62a and 62b, a second passage portion 63, and a second shaft opening 64. As illustrated in FIG. 1, the shaft inner axial passage portion 60 extends in the axial direction of the shaft 6.

Each of the first passage portions 61a and 61b is a passage located on the axially outer side with respect to the fan and connected to the shaft inner axial passage portion 60.

The first passage portion 61a is located on the one axial side P1 with respect to the first fan 4 to be described later. The first passage portion 61a penetrates the shaft 6 in the radial direction from the shaft inner axial passage portion 60 toward the outer peripheral surface of the shaft 6. The first passage portion 61a has the first shaft opening 62a opened to the outer peripheral surface of the shaft 6. The first shaft opening 62a is opened at a position on the one axial side P1 with respect to the first fan 4 to be described later. The first passage portion 61a connects the shaft inner axial passage portion 60 and the first shaft opening 62a.

The shaft 6 has a plurality of first passage portions 61a. For example, the shaft 6 has eight first passage portions 61a. As illustrated in FIG. 2, the plurality of first passage portions 61a are arranged in the circumferential direction of the shaft 6. The axial lengths of the plurality of first passage portions 61a are the same. The plurality of first passage portions 61a are positioned at intervals of 45 degrees in the circumferential direction of the shaft 6.

The first passage portion 61b is located on the other axial side P2 with respect to the second fan 5 to be described later. The first passage portion 61b penetrates the shaft 6 in the radial direction from the shaft inner axial passage portion 60 toward the outer peripheral surface of the shaft 6. The first passage portion 61b has the first shaft opening 62b opened to the outer peripheral surface of the shaft 6. The first shaft opening 62b is opened at a position on the other axial side P2 with respect to the second fan 5 to be described later. The first passage portion 61b connects the shaft inner axial passage portion 60 and the first shaft opening 62b.

The shaft 6 has a plurality of first passage portions 61b. For example, the shaft 6 has eight first passage portions 61b. As illustrated in FIG. 2, the plurality of first passage portions 61b are arranged in the circumferential direction of the shaft 6. The axial lengths of the plurality of first passage portions 61b are the same. The plurality of first passage portions 61b are positioned at intervals of 45 degrees in the circumferential direction of the shaft 6.

The second passage portion 63 is located at a position overlapping an axial center portion of the rotor core 7 when the rotor core 7 is viewed in the radial direction. The second passage portion 63 penetrates the shaft 6 in the radial direction from the shaft inner axial passage portion 60 toward the outer peripheral surface of the shaft 6. The second passage portion 63 has a second shaft opening 64 opened to the outer peripheral surface of the shaft 6. The second shaft opening 64 is located at a position overlapping the axial center portion of the rotor core 7 when the rotor core 7 is viewed in the radial direction. The second passage portion 63 connects the shaft inner axial passage portion 60 and the second shaft opening 64.

The shaft 6 has a plurality of second passage portions 63. For example, the shaft 6 has eight second passage portions 63. As illustrated in FIG. 2, the plurality of second passage portions 63 are arranged in the circumferential direction of the shaft 6. The axial lengths of the plurality of second passage portions 63 are the same. The plurality of second passage portions 63 are positioned at intervals of 45 degrees in the circumferential direction of the shaft 6.

A first total value that is the sum of the passage areas of the second passage portions 63 in the shaft 6 is equal to or larger than a second total value that is the sum of the passage areas of the first passage portions 61a and 61b in the shaft 6. Here, the first passage portions 61a and 61b and the second passage portions 63 have the same passage areas at any radial position. However, the inner peripheral surfaces of the first passage portions 61a and 61b and the second passage portion 63 may be tapered. That is, the passage areas of the first passage portions 61a and 61b and the second passage portion 63 may be different depending on the radial position. In the present embodiment, for example, the first total value is a value obtained by summing the smallest passage areas in the second passage portions 63 when the second passage portions 63 are viewed in the radial direction. The second total value is a value obtained by summing the smallest passage areas in the first passage portions 61a and 61b when the first passage portions 61a and 61b are viewed in the radial direction. As described above, in the calculation of each total value, the smallest portion of the passage area is used as a reference. Since the first total value is equal to or larger than the second total value, the passage area of the second passage portion 63 is secured. Therefore, the air smoothly flows in the second passage portion 63.

### (Rotor Core)

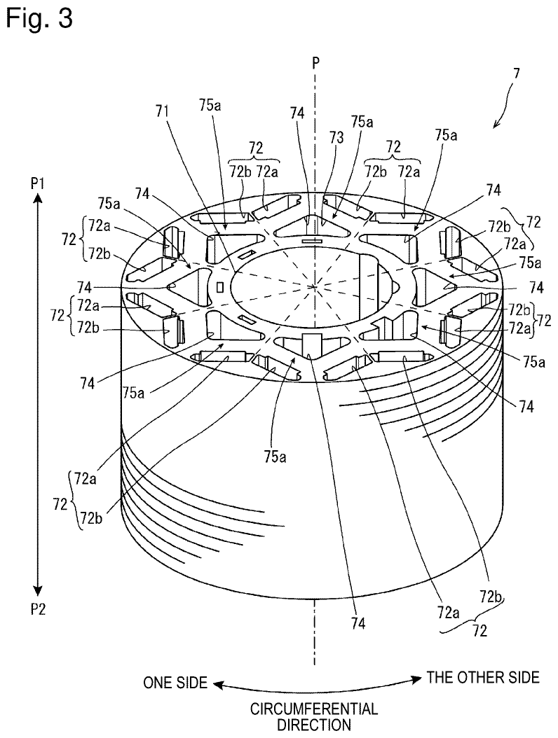

FIG. 3 illustrates an example of the rotor core 7 according to the first embodiment. The rotor core 7 is formed by stacking a plurality of core plates 8 formed by punching electromagnetic steel plates into a predetermined shape in the thickness direction. The core plate 8 will be described later in detail. As illustrated in FIG. 3, the rotor core 7 has a columnar shape. The rotor core 7 has a shaft insertion hole 71, a plurality of magnet insertion holes 72, and a plurality of air passages 73.

The shaft insertion hole 71 is located at the center of the rotor core 7 when the rotor core 7 is viewed in the axial direction. The shaft insertion hole 71 penetrates the rotor core 7 in the axial direction. The shaft 6 is inserted into the shaft insertion hole 71. The rotor core 7 is fixed to the shaft 6 and rotates about the central axis P together with the shaft 6.

As illustrated in FIG. 3, the rotor core 7 has a plurality of magnet insertion holes 72a extending radially outward toward one side in the circumferential direction and a plurality of magnet insertion holes 72b extending radially outward toward the other side in the circumferential direction. The magnet insertion hole 72a and the magnet insertion hole 72b form a pair. The rotor core 7 has eight magnet insertion holes 72a and 72b, respectively. The plurality of magnet insertion holes 72a and 72b are arranged in the circumferential direction of the rotor core 7. Rotor magnets (not illustrated) are accommodated in the magnet insertion holes 72a and 72b. Note that in FIG. 1, the magnet insertion holes 72a and 72b are not illustrated.

As illustrated in FIG. 3, the air passage 73 is located on the radially inner side with respect to the magnet insertion holes 72a and 72b in the rotor core 7. The air passage 73 is a passage for allowing the air to flow into the rotor core 7. As illustrated in FIG. 1, one air passage 73 includes a rotor core inner axial passage portion 74 and a plurality of connection passage portions 77.

The rotor core inner axial passage portion 74 is located on the radially inner side with respect to the magnet insertion holes 72a and 72b in the rotor core 7. The rotor core inner axial passage portion 74 is a portion that penetrates the rotor core 7 in the axial direction in the air passage 73. The rotor core inner axial passage portion 74 has a first rotor core opening 75a that is open at an end surface on the one axial side P1 of the rotor core 7 and a first rotor core opening 75b that is open at an end surface on the other axial side P2 of the rotor core 7. The rotor core inner axial passage portion 74 connects the first rotor core opening 75a on the one axial side P1 and the first rotor core opening 75b on the other axial side P2 to each other.

As illustrated in FIG. 3, the rotor core 7 includes eight rotor core inner axial passage portions 74. For example, the rotor core 7 has the rotor core inner axial passage portions 74 that is twice the number of pole pairs of the motor 100. The number of rotor core inner axial passage portions 74 may not be twice the number of pole pairs. The rotor core inner axial passage portions 74 are arranged at equal intervals in the circumferential direction of the rotor core 7. Specifically, the plurality of rotor core inner axial passage portions 74 are preferably located at intervals of 45 degrees (360/(number of poles×2)) in the circumferential direction of the shaft 6. When the rotor core 7 is viewed in the axial direction, the rotor core inner axial passage portion 74 has a triangular shape with a rounded vertex.

A broken line in FIG. 3 indicates a straight line connecting a region between the magnet insertion hole 72a and the magnet insertion hole 72b and the central axis P. As indicated by a broken line in FIG. 3, when the rotor core 7 is viewed in the axial direction, the rotor core inner axial passage portion 74 is not positioned between the central axis P and a region between the magnet insertion hole 72a and the magnet insertion hole 72b in the rotor core 7. As compared with a case where the rotor core inner axial passage portion 74 is positioned between the region and the central axis P, rigidity of the region can be secured in the rotor core 7, and a decrease in strength of the rotor core 7 is suppressed. Therefore, even if a radial force is applied to the rotor core 7, the radial deformation of the rotor core 7 is suppressed.

The connection passage portion 77 is located on the radially inner side with respect to the rotor core inner axial passage portion 74 in the rotor core 7. As illustrated in FIG. 1, the connection passage portion 77 penetrates the rotor core from the rotor core inner axial passage portion 74 toward the shaft insertion hole 71. The connection passage portion 77 has a second rotor core opening 76 that is open to the shaft insertion hole 71. The connection passage portion 77 extends from the rotor core inner axial passage portion 74 to the second rotor core opening 76. The connection passage portion 77 extends in a direction intersecting the axis of the shaft 6 and in a direction away from the axial center of the rotor core 7 as it goes radially outward.

The second rotor core opening 76 is located on the inner surface of the shaft insertion hole 71. As illustrated in FIG. 1, when the rotor core 7 is viewed in the radial direction, the second shaft opening 64 and the second rotor core opening 76 overlap each other. The second shaft opening 64 and the second rotor core opening 76 are connected to each other. Specifically, in the rotor 2, the second rotor core opening 76 and the second shaft opening 64 are located at positions facing each other, and the air can move between the second passage portion 63 and the connection passage portion 77. As a result, the air can move between the shaft inner axial passage portion 60 and the rotor core inner axial passage portion 74. As a result, the air flows between the connection passage portion 77 of the rotor core 7 and the second passage portion 63 of the shaft 6 via the second shaft opening 64 and the second rotor core opening 76.

### (Stator)

The stator 3 has a cylindrical shape. The stator 3 is positioned radially outside the rotor 2. The stator 3 includes a stator core 31 and a stator coil 32. The stator core 31 has a cylindrical shape. The stator core 31 has a plurality of slots arranged in the circumferential direction on the inner periphery. Each slot extends in the axial direction with respect to the stator 3. Note that illustration of the slot is omitted. The stator coil 32 extending in the axial direction is accommodated in each slot. The stator coil 32 is wound around the stator core 31. The stator coil 32 has a coil end portion 33 protruding axially outward from an axial end of the stator core 31.

### (First Fan)

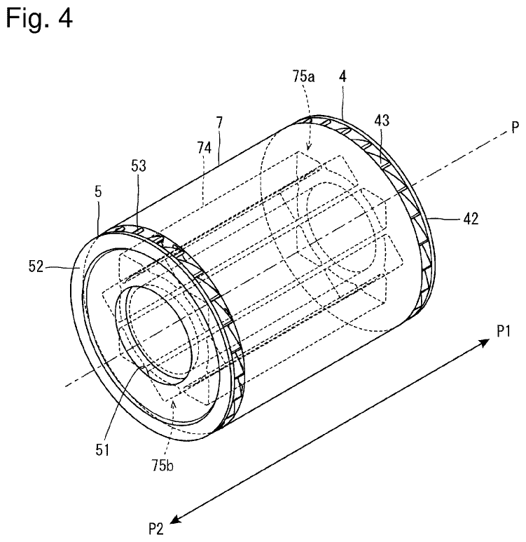

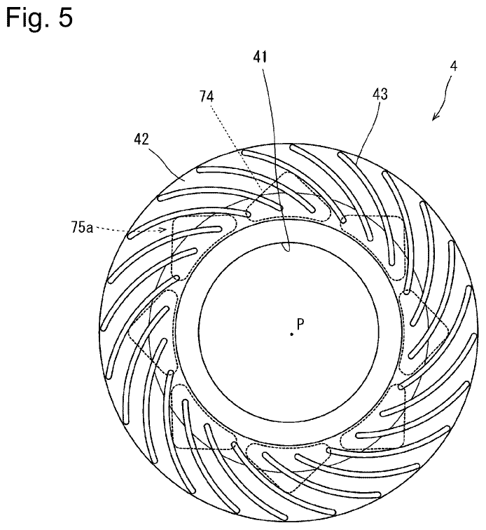

A first fan 4 according to the first embodiment will be described with reference to FIGS. 4 and 5. FIG. 4 is a perspective view illustrating the rotor core 7, the first fan 4, and a second fan 5 to be described later according to the first embodiment. FIG. 5 is a diagram illustrating an example of the first fan 4 according to the first embodiment. As illustrated in FIG. 4, the first fan 4 is located on the one axial side P1 of the rotor core 7. The first fan 4 is fixed to the shaft 6 and rotates together with the rotor core 7. In FIG. 4, illustration of the shaft 6 is omitted.

The first fan 4 is a centrifugal fan. As illustrated in FIG. 5, the first fan 4 includes a first fan through hole 41, a first base 42, and a plurality of first blades 43. The first fan through hole 41 is located at the center of the first fan 4 when the first fan 4 is viewed in the axial direction. The first fan through hole 41 penetrates the first fan 4 in the axial direction. The shaft 6 is inserted into the first fan through hole.

The first base 42 is an annular plate member. As illustrated in FIG. 5, the plurality of first blades 43 protrude in the axial direction on a surface on the other axial side P2, of the planes of the first base 42. Each of the first blades 43 extends radially outward. The plurality of first blades 43 are arranged at equal intervals in the circumferential direction. In order to suppress sound during rotation, the arrangement, shape, and circumferential interval of the plurality of first blades 43 may be non-uniform. The number of first blades 43 is not particularly limited. As illustrated in FIGS. 1 and 4, the first blade 43 is in contact with an end surface on the one axial side P1 of the rotor core 7.

The broken lines in FIGS. 4 and 5 illustrate examples of the positions of the rotor core inner axial passage portion 74 and the first rotor core opening 75a when the first fan 4 is viewed in the axial direction. As illustrated in FIG. 5, at least a part of the first blade 43 overlaps the first rotor core opening 75a when the rotor core 7 is viewed from the one axial side P1. That is, the first rotor core opening 75a and the suction port of the first fan 4 are connected to each other.

### (Second Fan)

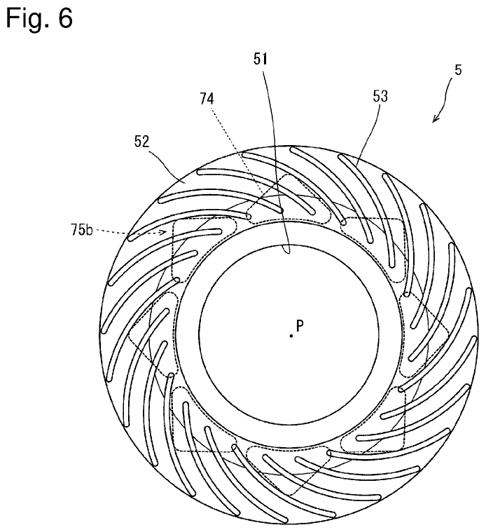

The second fan 5 according to the first embodiment will be described with reference to FIGS. 4 and 6. FIG. 6 is a diagram illustrating an example of the second fan 5 according to the first embodiment. As illustrated in FIG. 4, the second fan 5 is located on the other axial side P2 of the rotor core 7. The second fan 5 is fixed to the shaft 6 and rotates together with the rotor core 7.

The second fan 5 is a centrifugal fan. As illustrated in FIG. 6, the second fan 5 includes a second fan through hole 51, a second base 52, and a plurality of second blades 53. The second fan through hole 51 is located at the center of the second fan 5 when the second fan 5 is viewed in the axial direction. The second fan through hole 51 penetrates the second fan 5 in the axial direction. The shaft 6 is inserted into the second fan through hole.

The second base 52 is an annular plate member. As illustrated in FIG. 6, the plurality of second blades 53 protrude in the axial direction on a surface on the other axial side P2, of the planes of the second base 52. Each of the second blades 53 extends radially outward. The plurality of second blades 53 are arranged at equal intervals in the circumferential direction. In order to suppress sound during rotation, the arrangement, shape, and circumferential interval of the plurality of second blades 53 may be non-uniform. The number of second blades 53 is not particularly limited. As illustrated in FIGS. 1 and 4, the second blade 53 is in contact with an end face on the other axial side P2 of the rotor core 7.

The broken lines in FIGS. 4 and 6 indicate examples of the positions of the rotor core inner axial passage portion 74 and the first rotor core opening 75b when the second fan 5 is viewed from the axial direction. As illustrated in FIG. 6, at least a part of the second blade 53 overlaps the first rotor core opening 75b when the rotor core 7 is viewed from the other axial side P2. That is, the first rotor core opening 75b and the suction port of the second fan 5 are connected to each other.

### (Fixing Member)

The shaft 6 is inserted into the fixing member 10. The fixing member 10 is located on the one axial side P1 with respect to the first fan 4. The fixing member 10 is in contact with the first fan 4. For example, the fixing member 10 is a nut. As illustrated in FIGS. 1 and 2, the shaft 6 has a pressing portion 65 protruding in the radial direction from the outer peripheral surface of the shaft 6. The pressing portion 65 is located on the other axial side P2 with respect to the second passage portion 63 and on the one axial side P1 with respect to the first passage portion 61b. The first fan 4, the rotor core 7, and the second fan 5 are sandwiched between the fixing member 10 and the pressing portion 65. An end surface on the other axial side P2 of the second fan 5 comes into contact with the pressing portion 65. When the fixing member 10 is tightened, the rotor core 7, the first fan 4, and the second fan 5 are fixed to the shaft 6.

### (Rolling of Core Plate 8)

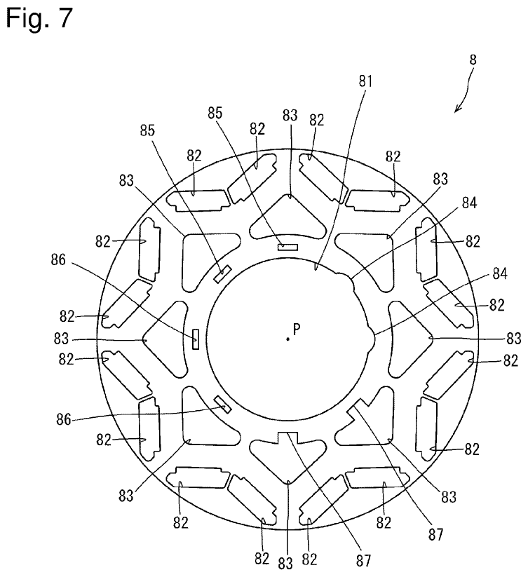

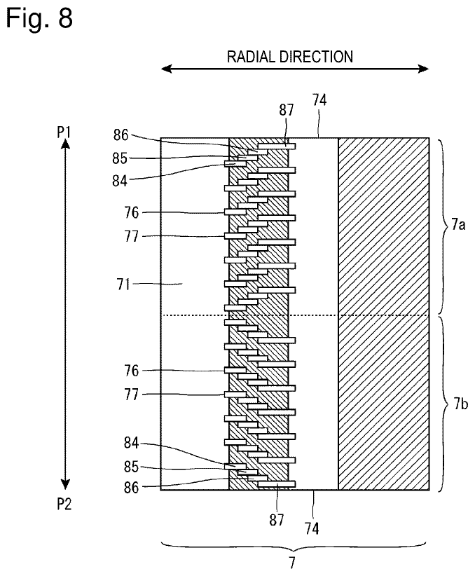

In the rotor core 7 of the first embodiment, the second rotor core opening 76 and the connection passage portion 77 can be configured by rolling of the core plate 8. An example of rolling of the core plate 8 will be described below with reference to FIGS. 7 and 8. FIG. 7 illustrates an example of the core plate 8 according to the first embodiment. FIG. 8 is an enlarged cross-sectional view of the rotor core 7 including the central axis P and the connection passage portion 77.

First, rolling means that core plates 8 having the same shape and the same size are stacked while being rotated in a certain direction by a predetermined angle. In the rolling of the core plates 8 of the first embodiment, each of the core plates 8 is rotated in the clockwise direction or the counterclockwise direction by 90 degrees.

As illustrated in FIG. 7, the core plate 8 includes a first insertion hole 81, a second insertion hole 82, and an axial passage hole 83. The first insertion hole 81 is located at the center of the core plate 8. The first insertion holes 81 of the stacked core plates 8 constitute the shaft insertion hole 71 of the rotor core 7. The core plate 8 has sixteen second insertion holes 82 along the circumferential direction. When the core plates 8 are stacked while being rotated by 90 degrees, the second insertion holes 82 are located at positions where the positions of the second insertion holes 82 of the core plates 8 coincide with each other, when the core plates 8 are viewed in the axial direction. The second insertion holes 82 of the stacked core plates 8 constitute the magnet insertion hole 72 of the rotor core 7.

The core plate 8 has eight axial passage holes 83 arranged in the circumferential direction. The axial passage hole 83 is located on the radially inner side with respect to the second insertion hole 82. When the core plates 8 are stacked while being rotated by 90 degrees, the axial passage holes 83 are located at positions where the positions of the axial passage holes 83 of the core plates 8 coincide with each other, when the core plates 8 are viewed in the axial direction. The axial passage holes 83 of the stacked core plates 8 constitute the rotor core inner axial passage portion 74 of the air passage 73 in the rotor core 7.

Further, the connection passage portion 77 and the second rotor core opening 76 are formed by the rolling of the core plates 8. Specifically, the core plate 8 includes a first notch 84, a first slit 85, a second slit 86, and a second notch 87. When the core plate 8 is viewed in the axial direction, the first notch 84, the first slit 85, the second slit 86, and the second notch 87 are distant in this order from the central axis P. The distance from the central axis P means the shortest distance from the central axis P to each of the first notch 84, the first slit 85, the second slit 86, and the second notch 87.

The first notch 84, the first slit 85, the second slit 86, and the second notch 87 are each located between the axial passage hole 83 and the first insertion hole 81. Further, two first notches 84, two first slits 85, two second slits 86, and two second notches 87 are positioned at intervals of 45 degrees in the circumferential direction in the core plate 8. The first notch 84 is connected to the first insertion hole 81. The second notch 87 is connected to the axial passage hole 83.

Description will be given on an example in which the core plate 8 illustrated in FIG. 7 is stacked on the one axial side P1 while being rotated by 90 degrees in the clockwise direction. For example, when the core plate 8 is viewed in the axial direction, the first slit 85 is located at a position overlapping a part of the second slit 86 of the core plate 8 adjacent to the one axial side P1 and a part of the first notch 84 of the core plate 8 adjacent to the other axial side P2. For example, when the core plate 8 is viewed in the axial direction, the second slit 86 is located at a position overlapping a part of the second notch 87 of the core plate 8 adjacent to the one axial side P1 and a part of the first slit 85 of the core plate 8 adjacent to the other axial side P2. As a result, the first notch 84 and the second notch 87 are connected to each other by the first slit 85 and the second slit 86. Therefore, the first notch 84, the first slit 85, the second slit 86, and the second notch 87 constitute the connection passage portion 77. In FIG. 1, illustration of the connection passage portion 77 not connected to the second passage portion 63 is omitted.

An example of manufacturing the rotor core 7 of the first embodiment will be specifically described. One rotor core 7 includes two blocks 7a and 7b obtained by rolling the core plates 8. The axial length of each of the two blocks 7a and 7b is ½ of the axial length of the rotor core 7. The two blocks 7a and 7b are arranged and connected in plane symmetry with respect to a plane orthogonal to the central axis P. That is, in one of the two blocks 7a and 7b, the stacking order of the core plates 8 is opposite to that of the other block in the axial direction.

Here, in the first block 7a, the connection passage portion 77 extends toward the one axial side P1 as it goes radially outward. In the second block 7b, the connection passage portion 77 extends toward the other axial side P2 as it goes radially outward. As illustrated in FIG. 8, in a state where the first block 7a is located on the one axial side P1 and the second block 7b is located on the other axial side P2, the axial end surfaces of the first block 7a and the second block 7b are joined to each other, thereby forming one rotor core 7.

When the rotor core 7 is viewed in the axial direction, the first block 7a and the second block 7b may be overlapped at an angle at which the positions of the magnet insertion holes 72 completely coincide with each other. In order to suppress the cogging torque, when the rotor core 7 is viewed in the axial direction, the first block 7a and the second block 7b may be overlapped in a state where the first block 7a is rotated by about several degrees in the circumferential direction from the angle at which the magnet insertion holes 72 are completely coincide with each other.

The broken line illustrated in FIG. 8 indicates an example of an axial center of the rotor core 7, that is, a boundary between the first block 7a and the second block 7b. With the first block 7a and the second block 7b being overlapped, as illustrated in FIG. 8, each of the plurality of connection passage portions 77 extends in a direction intersecting the axis of the shaft 6 and in a direction away from the axial center of the rotor core 7 as it goes radially outward.

### (Cooling of Motor)

Next, an example of cooling by the air in the motor 100 according to the first embodiment will be described with reference to FIG. 1. In FIG. 1, a broken-line arrow indicates an example of a direction in which the air flows when the first fan 4 and the second fan 5 rotate with the rotation of the shaft 6.

When the rotor 2 rotates about the central axis P, the shaft 6 and the rotor core 7 rotate. As the shaft 6 and the rotor core 7 rotate, the first fan 4 and the second fan 5 also rotate. The first fan 4 and the second fan 5, which are centrifugal fans, cause the air in the rotor core inner axial passage portion 74 to flow radially outward by the rotation.

Since the second rotor core opening 76 of the connection passage portion 77 of the rotor core 7 and the second shaft opening 64 of the second passage portion 63 of the shaft 6 are connected to each other, the connection passage portion 77 of the rotor core 7 and the second passage portion 63 of the shaft 6 are connected to each other. In addition, the connection passage portion 77 of the rotor core 7 and the rotor core inner axial passage portion 74 are connected to each other, and the second passage portion 63 of the shaft 6 and the shaft inner axial passage portion 60 are connected to each other. Therefore, the rotor core inner axial passage portion 74 is connected to the shaft inner axial passage portion 60 of the shaft 6. As a result, when the first fan 4 and the second fan 5 rotate, the air flows from the first shaft openings 62a and 62b toward the shaft inner axial passage portion 60 in the shaft 6.

Specifically, the air outside the shaft 6 and on the one axial side P1 with respect to the first fan 4 flows to the shaft inner axial passage portion 60 through the first shaft opening 62a and the first passage portion 61a. Further, the air outside the shaft 6 and on the other axial side P2 of the second fan 5 flows to the shaft inner axial passage portion 60 through the first shaft opening 62b and the first passage portion 61b.

The air in the shaft inner axial passage portion 60 flows in a direction toward the second passage portion 63. For example, on the one axial side P1 with respect to the second passage portion 63, the air in the shaft inner axial passage portion 60 flows from the one axial side P1 toward the other axial side P2. On the other axial side P2 with respect to the second passage portion 63, the air in the shaft inner axial passage portion 60 flows from the other axial side P2 toward the one axial side P1.

The air that has reached the second passage portion 63 flows to the connection passage portion 77 via the second shaft opening 64 and the second rotor core opening 76. Further, the air in the connection passage portion 77 flows in the direction of the rotor core inner axial passage portion 74. In this manner, the air passing through the shaft 6 flows into the rotor core inner axial passage portion 74 of the rotor core 7.

Here, the second passage portion 63 is located at a position overlapping an axial center portion of the rotor core 7 when the rotor core 7 is viewed in the radial direction. Therefore, the air passing through the second passage portion 63 and the connection passage portion 77 cools the axial center portion of the rotor core 7.

Further, as illustrated in FIGS. 1 and 8, each of the plurality of connection passage portions 77 extends in a direction intersecting the axis of the shaft 6 and in a direction away from the axial center of the rotor core 7 as it goes radially outward. Therefore, in the central portion in the axial direction of the rotor core 7, collision and stay of the air in the air passage 73 are suppressed.

In the rotor core inner axial passage portion 74, the air flows from the axial center portion of the rotor core 7 to the one axial side P1 by the rotating first fan 4. The air flowing in the rotor core inner axial passage portion 74 cools the inside of the rotor core 7. Further, the first blades 43 of the first fan 4 allow the air to flow radially outward. As illustrated in FIG. 1, when the stator 3 is viewed in the radial direction, the first blade 43 overlaps at least a part of the coil end portion 33 on the one axial side P1. Therefore, the air discharged radially outward from the first fan 4 hits the coil end portion 33 on the one axial side P1. As a result, the coil end portion 33 on the one axial side P1 is cooled.

In the rotor core inner axial passage portion 74, the air flows from the axial center portion of the rotor core 7 to the other axial side P2 by the rotating second fan 5. The air flowing in the rotor core inner axial passage portion 74 cools the inside of the rotor core 7. Then, the second blades 53 of the second fan 5 allow the air to flow radially outward. As illustrated in FIG. 1, when the stator 3 is viewed in the radial direction, the second blade 53 overlaps at least a part of the coil end portion 33 on the other axial side P2. Therefore, the air discharged radially outward from the second fan 5 hits the coil end portion 33 on the other axial side P2. As a result, the coil end portion 33 on the other axial side P2 is cooled.

After flowing in the rotor core 7 as described above, the air flowing to the coil end portion 33 can cool the rotor core 7 and the coil end portion 33. Therefore, with the configuration of the motor 100 of the present embodiment, it is possible to efficiently cool the rotor core 7 and the coil end portion 33 while circulating the air around the rotor core 7.

As described above, the motor 100 according to the first embodiment includes the rotor 2 and the stator 3. The rotor 2 includes the shaft 6 extending in the axial direction of the central axis P and the rotor core 7 having the shaft insertion hole 71 into which the shaft 6 is inserted. The stator 3 is located radially outside the rotor core 7. The motor 100 is fixed to the shaft 6 or the rotor core 7 at a position axially outside the rotor core 7, and includes a fan that rotates together with the rotor core 7. The rotor core 7 has the air passage 73. The shaft 6 has the shaft inner passage 6a. The air passage 73 includes the first rotor core openings 75a and 75b that area open to the axial end surface of the rotor core 7, and the second rotor core opening 76 that is open to the shaft insertion hole 71. The shaft inner passage 6a includes the first shaft openings 62a and 62b that open at positions on the axially outer side with respect to the fan and the second shaft opening 64 that is open at a position connected to the second rotor core opening 76, and is connected to the air passage 73 by the second rotor core opening 76 and the second shaft opening 64 connected to each other.

According to the above configuration, the first shaft opening 62a is located on the axially outer side with respect to the first fan 4, and the first shaft opening 62b is located on the axially outer side with respect to the second fan 5. Therefore, when the first fan 4 and the second fan 5 rotate with the rotation of the rotor core 7, the air flows through the shaft inner passage 6a. Since the second rotor core opening 76 of the air passage 73 and the second shaft opening 64 of the shaft inner passage 6a are connected to each other, the air flows through the shaft inner passage 6a and the air passage 73 of the rotor core 7 connected to the shaft inner passage 6a. As a result, the air can flow into the air passage 73 of the rotor core 7 by the rotation of the first fan 4 and the second fan 5, and the rotor core 7 can be efficiently cooled.

The shaft inner passage 6a includes the first passage portion 61a connecting the shaft inner axial passage portion 60 extending in the axial direction of the shaft 6 and the first shaft opening 62a, the first passage portion 61b connecting the shaft inner axial passage portion 60 and the first shaft opening 62b, and the second passage portion 63 connecting the shaft inner axial passage portion 60 and the second shaft opening 64.

According to the above-described configuration, a configuration is realized in which the shaft inner passage 6a of the shaft 6 is connected to the air passage 73 of the rotor core 7, and the air flows into the shaft inner passage 6a and the air passage 73. Therefore, the first fan 4 and the second fan 5 can cause the air to flow into the air passage 73 of the rotor core 7. The rotor core 7 can be efficiently cooled.

The second passage portion 63 is located at a position overlapping an axial center portion of the rotor core 7 when the rotor core 7 is viewed in the radial direction. According to the above configuration, the air flowing through the two passage portion 63 cools the axial central portion of the rotor core 7 where heat hardly escapes. As a result, the rotor core 7 is efficiently cooled.

The air passage 73 includes the rotor core inner axial passage portion 74 extending in the axial direction of the rotor core 7, and a plurality of connection passage portions 77 extending radially inward of the rotor core 7 from the rotor core inner axial passage portion 74 and connecting the rotor core inner axial passage portion 74 and the second rotor core opening 76. Each of the plurality of connection passage portions 77 extends in a direction intersecting the axis of the shaft 6 and in a direction away from the axial center of the rotor core 7 as it goes radially outward.

According to the above configuration, the plurality of connection passage portions 77 connected to the rotor core inner axial passage portion 74 respectively in the air passage 73 of the rotor core 7 extend in the direction intersecting the central axis P and in the direction away from the axial center of the rotor core 7 as they go the radial outside. As a result, the air can smoothly flow from the connection passage portion 77 into the rotor core inner axial passage portion 74. In the central portion of the rotor core 7 in the axial direction, collision and stay of the air in the air passage 73 are suppressed. Therefore, the rotor core 7 can be efficiently cooled.

The fan includes the first fan 4 and the second fan 5. The first fan 4 is located on the one axial side P1 with respect to the rotor core 7. The second fan 5 is located on the other axial side P2 with respect to the rotor core 7. The shaft inner passage 6a has a plurality of first shaft openings. The first shaft opening 62a is located on the one axial side P1 with respect to the first fan 4 when the shaft 6 is viewed in the radial direction. The first shaft opening 62b is located on the other axial side P2 with respect to the second fan 5 when the shaft 6 is viewed in the radial direction.

According to the above configuration, the air can flow into the air passage 73 of the rotor core 7 and the shaft inner passage 6a by the first fan 4 located on the one axial side P1 and the second fan 5 located on the other axial side P2. As a result, the rotor core 7 can be efficiently cooled.

The first passage portions 61a and 61b and the second passage portion 63 of the shaft 6 extend in the radial direction. The first total value that is the sum of the passage areas of the second passage portions 63 in the shaft 6 is equal to or larger than the second total value that is the sum of the passage areas of the first passage portions 61a and the first passage portions 61b in the shaft 6. The first total value is a value obtained by summing the smallest passage areas in the second passage portions 63 when the second passage portions 63 are viewed in the radial direction. The second total value is a value obtained by summing the smallest passage areas of the first passage portion 61a and the first passage portion 61b when the first passage portion 61a and the first passage portion 61b are viewed in the radial direction.

According to the above configuration, the first total value that is the total passage area of the second passage portions 63 is equal to or larger than the second total value that is the total passage area of the first passage portion 61a and the first passage portion 61b. Since the passage area of the second passage portion 63 is large, the air flows smoothly through the second passage portion 63 of the shaft 6. Therefore, a sufficient amount of air flows between the shaft inner passage 6a and the inside of the rotor core 7. Therefore, the efficiency of cooling the rotor core 7 is improved.

The rotor core 7 has the magnet insertion hole 72 into which a rotor magnet is inserted. The air passage 73 is positioned on the radially inner side with respect to the magnet insertion hole 72 in the rotor core 7. According to the above configuration, since the air passage 73 of the rotor core 7 is located on the radially inner side with respect to the magnet insertion hole 72, the rotor core 7 can be efficiently cooled. Moreover, the weight of the rotor core 7 can be reduced by providing the air passage 73.

The stator 3 includes the stator core 31 having a plurality of slots, and stator coils accommodated in the slots of the stator core 31. The first fan 4 and the second fan 5 are centrifugal fans having a plurality of blades. When the stator 3 is viewed in the radial direction, the first blades 43 of the first fan 4 and the second blades 53 of the second fan 5 overlap at least a part of the coil end portion 33 of the stator coil 32 protruding axially outward from the stator core 31.

According to the above configuration, the first fan 4 and the second fan 5 cause the air to flow radially outward toward the coil end portion 33 of the stator coil. The air flowing radially outward by the first fan 4 and the second fan 5 hits the coil end portion 33. Accordingly, the coil end portion 33 is cooled.

At least a part of the first blade 43 of the first fan 4 overlaps the first rotor core opening 75a when the rotor core 7 is viewed in the axial direction. At least a part of the second blade 53 of the second fan 5 overlaps the first rotor core opening 75b when the rotor core 7 is viewed in the axial direction.

According to the above configuration, when the fan is viewed in the axial direction, the opening of the air passage 73 in the end surface of the rotor core 7 and at least a part of the first blade 43 of the first fan 4 overlap each other, and the opening of the air passage 73 in the end surface of the rotor core 7 and at least a part of the second blade 53 of the second fan 5 overlap each other. Therefore, the first fan 4 and the second fan 5 can efficiently cause the air flowing from the air passage 73 to flow radially outward.

The motor 100 includes the casing 1 that accommodates the rotor core 7, the stator 3, the shaft 6, the first fan 4, and the second fan 5. According to the above configuration, the rotor core 7, the stator 3, the shaft 6, the first fan 4, and the second fan 5 are located in the casing 1. Thus, the flow of the air by the fan can be easily formed in the casing 1. Therefore, the motor 100 can be efficiently cooled. Furthermore, the internal space of the casing 1 may be a sealed space. That is, the rotor core 7, the stator 3, the fans, the air, and the shaft 6 may be located in a sealed space. In this case, external air does not flow into the internal space. Dust, powder dust, and dirt outside the motor 100, that is, contamination, do not enter the motor 100. As a result, since contamination is not mixed, the motor 100 is not adversely affected by the contamination.

### (Modifications)

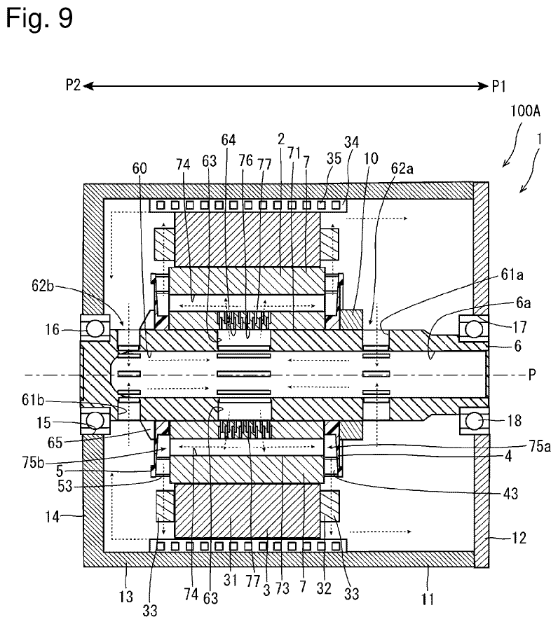

FIG. 9 is a diagram illustrating an example of a motor 100A according to a modification of the first embodiment. In the motor 100A, a cooling unit 34 is added to the motor 100 of the first embodiment, but the configuration other than the cooling unit 34 is the same. The same components as those of the first embodiment are denoted by the same reference signs, and the description thereof is omitted.

The motor 100A includes the cooling unit 34. The cooling unit 34 has, for example, a cylindrical shape. Note that the cooling unit 34 may not have a cylindrical shape. The cooling unit 34 extends in the axial direction. The cooling unit 34 is positioned between the stator 3 and the cylindrical portion 13 of the first casing member 11. The radially inner surface of the cooling unit 34 is in contact with the radially outer surface of the stator 3. The radially outer surface of the cooling unit 34 is in contact with the inner surface of the cylindrical portion 13. The cooling unit 34 may be a component to be retrofitted to the first casing member 11, or may be molded as a part of the first casing member 11.

The cooling unit 34 includes a refrigerant flow path 35 therein. The refrigerant flow path 35 is a flow path through which refrigerant flows. For example, one refrigerant flow path 35 meanders in the cooling unit 34. The refrigerant is, for example, liquid such as water. The refrigerant may be liquid other than water. The cooling unit 34 includes an outflow portion (not illustrated) and an inflow portion (not illustrated). A cooling device (not illustrated) cools the refrigerant flowing out of the outflow portion, and causes the cooled refrigerant to flow from the inflow portion into the refrigerant flow path 35.

The cooling unit 34 of the motor 100A cools the outer peripheral side of the stator core 31. When the stator 3 is viewed in the radial direction, the blades of the first fan 4 and the second fan 5 overlap a part of the cooling unit 34. As a result, the air discharged from the first fan 4 and the second fan 5 flows toward the cooling unit 34 and is cooled by the cooling unit 34. Since the air around the motor 100 is cooled by the cooling unit 34, the rotor core 7 and the stator coil can be efficiently cooled.

### Other Embodiments

The foregoing description concerns an embodiment of the present invention; however, the foregoing embodiment is merely an example for embodying the present invention. Thus, the present invention is not limited to the embodiment described above, and the embodiment described above may be appropriately modified and implemented without departing from the scope of the present invention.

In the embodiment described above, the number of the first passage portions 61a is eight, the number of the first passage portions 61b is eight, and the number of the second passage portions 63 is eight. However, the number of the first passage portions and the number of the second passage portions may be one or more, seven or less, or nine or more.

In the above embodiment, an example has been described in which the number of the magnet insertion holes 72 is sixteen and the number of the rotor core inner axial passage portions 74 is eight. However, the number of magnet insertion holes may be fifteen or less, or seventeen or more. The number of the rotor core inner axial passage portions may be one or more, seven or less, or nine or more.

In the above embodiment, the rotor core 7 has the air passage 73 separately from the shaft insertion hole 71 and the magnet insertion hole 72. However, either one or both of the shaft insertion hole and the magnet insertion hole may be used as the air passage.

In the above embodiment, the first fan 4 and the second fan 5 cause the air to flow axially outward from the central portion in the axial direction of the rotor core 7. However, the first fan and the second fan may cause the air to flow toward the central portion in the axial direction of the rotor core 7. Then, the air may flow from the connection passage portion toward the second passage portion, and the air may flow from the first passage portion toward the outside of the shaft. That is, the air may flow in a direction opposite to that of the embodiment.

In the embodiment described above, the shaft 6 has the shaft inner passage 6a opened at a position on the axially outer side with respect to the first fan 4 and opened at a position on the axially outer side with respect to the second fan 5. However, the shaft inner passage may open only at one of the position on the axially outer side with respect to the first fan and the position on the axially outer side with respect to the second fan.

In the above embodiment, the first fan 4 and the second fan 5 are fixed to the shaft 6. However, the first fan and the second fan may be fixed to the rotor core. The number of fans fixed to the shaft may be one.

In the above embodiment, the first fan 4 and the second fan 5 are centrifugal fans. However, the first fan may be an axial fan. The second fan may be an axial fan. Further, the first fan and the second fan may have the same shape, the same size, different shapes, or different sizes.

In the above embodiment, the end face on the one axial side P1 of the rotor core 7 and the first fan 4 are in contact with each other. However, the motor may have a first scattering prevention plate between the end face on one axial side of the rotor core 7 and the first fan. The shaft is inserted into the first scattering prevention plate. The first scattering prevention plate is fixed to the shaft or the rotor core and rotates together with the rotor core. The first scattering prevention plate closes the opening of the magnet insertion hole in the end face on one axial side of the rotor core. The first scattering prevention plate has a first vent hole that penetrates the first scattering prevention plate in the axial direction and overlaps the rotor core inner axial passage portion when viewed in the axial direction. The first scattering prevention plate does not close the first rotor core opening due to the first vent hole.

In the above embodiment, the end face on the other axial side P2 of the rotor core 7 and the second fan 5 are in contact with each other. However, the motor may have a second scattering prevention plate between the end face on the other axial side of the rotor core 7 and the second fan. The shaft is inserted into the second scattering prevention plate. The second scattering prevention plate is fixed to the shaft or the rotor core and rotates together with the rotor core. The second scattering prevention plate closes the opening of the magnet insertion hole in the end face on the other axial side of the rotor core. The second scattering prevention plate has a second vent hole penetrating the second scattering prevention plate in the axial direction and overlapping the rotor core inner axial passage portion when the rotor core is viewed in the axial direction. The second scattering prevention plate does not close the first rotor core opening due to the second vent hole.

In the above embodiment, the connection passage portion 77 of the rotor core 7 is formed by rolling. However, the connection passage portion may be, for example, a hole opened by a drill or the like, or may be configured by a method other than rolling.

In the above embodiment, the first total value that is the sum of the opening areas of the second passage portions 63 in the shaft 6 is equal to or larger than the second total value that is the sum of the opening areas of the first passage portions 61a and the first passage portions 61b in the shaft 6. However, the first total value may be less than the second total value.

In the above embodiment, the air passage 73 is located on the radially inner side with respect to the magnet insertion hole 72 in the rotor core 7. However, the air passage may be located on the radially outer side with respect to the magnet insertion hole in the rotor core.

In the above embodiment, when the stator 3 is viewed in the radial direction, the first blades 43 of the first fan 4 and the second blades 53 of the second fan 5 overlap at least a part of the coil end portion 33 of the stator coil 32 protruding axially outward from the stator core 31. However, when the stator 3 is viewed in the radial direction, the first blades of the first fan and the second blades of the second fan may not overlap the coil end portion.

In the above embodiment, the rotor core inner axial passage portion 74 has a triangular shape with a rounded vertex when the rotor core 7 is viewed in the axial direction. However, when the rotor core 7 is viewed in the axial direction, the shape of the rotor core inner axial passage portion is not limited to the triangular shape, and may be, for example, a circle, an ellipse, or a rectangle.

In the above embodiment, the internal space formed by the first casing member 11 and the second casing member 12 is a sealed space. However, the internal space formed by the first casing member and the second casing member may not be sealed. Either one or both of the first casing member and the second casing member may be opened.

### INDUSTRIAL APPLICABILITY

The present invention is applicable to a motor including a rotor core and a fan that rotates together with the rotor core.

1. A motor comprising:
a rotor including a shaft extending in an axial direction of a central axis, and
a rotor core having a shaft insertion hole into which the shaft is inserted; and
a stator located radially outside the rotor core,
wherein the motor further comprises a fan that is fixed to the shaft or the rotor core at a position axially outside the rotor core and rotates together with the rotor core,
the rotor core has an air passage,
the shaft has a shaft inner passage,
the air passage includes a first rotor core opening opened to an axial end surface of the rotor core and a second rotor core opening opened to the shaft insertion hole, and
the shaft inner passage includes a first shaft opening opened at a position on an axially outer side with respect to the fan and a second shaft opening opened at a position connected to the second rotor core opening, and the second rotor core opening and the second shaft opening are connected to each other, so that the shaft inner passage is connected to the air passage.

2. The motor according to claim 1, wherein
the shaft inner passage includes
a shaft inner axial passage portion extending in an axial direction of the shaft,
a first passage portion connecting the shaft inner axial passage portion and the first shaft opening to each other, and
a second passage portion connecting the shaft inner axial passage portion and the second shaft opening to each other.

3. The motor according to claim 2, wherein the second passage portion is located at a position overlapping an axial center portion of the rotor core when the rotor core is viewed in a radial direction.

4. The motor according to claim 1, wherein
the air passage includes
a rotor core inner axial passage portion extending in an axial direction of the rotor core, and
a plurality of connection passage portions extending radially inward of the rotor core from the rotor core inner axial passage portion and connecting the rotor core inner axial passage portion and the second rotor core opening, and
each of the plurality of connection passage portions extends in a direction intersecting the central axis and in a direction away from an axial center of the rotor core as going radially outward.

5. The motor according to claim 2, wherein
the fan includes a first fan and a second fan,
the first fan is located on one side in the axial direction with respect to the rotor core,
the second fan is located on another side in the axial direction with respect to the rotor core,
the shaft inner passage includes a plurality of first shaft openings, and
the plurality of first shaft openings are located on the one side in the axial direction with respect to the first fan and on the other side in the axial direction with respect to the second fan when the shaft is viewed in the radial direction.

6. The motor according to claim 2, wherein
the first passage portion and the second passage portion extend in the radial direction,
a first total value that is a sum of passage areas of the second passage portions in the shaft is equal to or larger than a second total value that is a sum of passage areas of the first passage portions in the shaft,
the first total value is a value obtained by summing smallest passage areas in the second passage portions when the second passage portions are viewed in the radial direction, and
the second total value is a value obtained by summing smallest passage areas in the first passage portions when the first passage portions are viewed in the radial direction.

7. The motor according to claim 1, wherein
the rotor core has a magnet insertion hole into which a rotor magnet is inserted, and
the air passage is located on a radially inner side with respect to the magnet insertion hole in the rotor core.

8. The motor according to claim 1, wherein
the stator includes
a stator core having a plurality of slots, and
a stator coil accommodated in each of the slots of the stator core,
the fan is a centrifugal fan having a plurality of blades, and
the blade of the fan overlaps at least a part of a coil end portion of the stator coil protruding axially outward from the stator core when the stator is viewed in the radial direction.

9. The motor according to claim 8, comprising a cooling unit that cools an outer peripheral side of the stator core,
wherein the blade of the fan overlaps a part of the cooling unit when the stator is viewed in the radial direction.

10. The motor according to claim 8, wherein at least a part of the blade of the fan overlaps the first rotor core opening when the rotor core is viewed in the axial direction.

11. The motor according to claim 1, further comprising a casing that accommodates the rotor, the stator, the shaft, and the fan.
